(19) United States
(12) Patent Application Publication
(10) Pub. No.: US 2025/0223436 A1
(43) Pub. Date: Jul. 10, 2025

(54) BIODEGRADABLE THERMOPLASTIC BLEND COMPOSITIONS WITH ELASTOMER-INDUCED FORCE RECOVERY PROPERTIES AND THE METHODS OF PRODUCTION THEREOF

(71) Applicant: Erthos Inc., Mississauga (CA)

(72) Inventors: Emmanuel Olusegun OGUNSONA, Mississauga, Ontario (CA); Nima ZARRINBAKHSH, Mississauga, Ontario (CA); Hossein ABDOLI, Mississauga, Ontario (CA); Shadi Meshkat ALSADAT, Mississauga, Ontario (CA); Devni Nayanathara ELAMALDENIYA, Mississauga, Ontario (CA)

(21) Appl. No.: 18/404,500

(22) Filed: Jan. 4, 2024

(51) Int. Cl. C08L 67/04; B29B 7/00; B29C 48/00; B29C 48/08; B29K 67/00; C08K 5/11; C08L 3/04; C08L 67/02

(52) U.S. Cl. CPC C08L 67/04; B29B 7/005; B29C 48/022; B29C 48/08; C08K 5/11; C08L 3/04; C08L 67/02; B29C 2948/92704; B29K 2067/046; C08L 2201/06; C08L 2203/16; C08L 2203/30; C08L 2205/02; C08L 2205/03

(57) ABSTRACT

The invention is a range of biodegradable thermoplastic compositions that exhibit force and form recovery. It encompasses thermoplastic polymer compositions which comprise at least one biodegradable thermoplastic polyester and at least one elastomer, and optionally other additives including, but not limited to, plasticizers, processing aids, compatibilizers, fillers, coupling agents, and initiators. Different levels of force recovery can be achieved through resin preparation from different ingredient combinations and concentrations. The compositions exhibit physical and mechanical properties similar to those used for film and injection molding applications.

### FIELD OF INVENTION

The invention encompasses the development of biodegradable thermoplastic polyester compositions for applications, such as extruded films, sheets, and profiles as well as injection molded parts, within which “force recovery” property is possessed as a targeted main advantage of the mechanical properties. Moreover, the invention encompasses the use of a specified weight percentage ranges of biodegradable thermoplastic polyesters, bio-based polyester elastomers, plasticizers, fillers, and other additives and combinations thereof, and protocols for the production of the biodegradable resins and evaluation of the force recovery of such products.

### BACKGROUND OF THE INVENTION

In the realm of conventional and petroleum-based polymeric materials, the force recovery behavior is present in elastomeric materials as observed from their strain recovery property. Such elastomeric materials include styrene block copolymers, thermoplastic polyolefin elastomers, thermoplastic copolyesters and thermoplastic polyurethanes, natural rubber and butadiene rubber just to mention a few. The strain recovery of these elastomers allow for high strains at high strain rates and a return to their original shape and form with little to no loss in strength.

Some examples of functional applications of polymers with great elasticity include:
a. Seals and gaskets: Polymers with good elasticity are often used to make seals and gaskets, as deformation can occur to fit around other components while also creating a resistance to the deformation as the material tends to return to its original shape and form, thereby creating a tight seal.
b. Sporting goods: The elasticity of a polymer can affect the performance of sporting goods, such as balls and gloves. For example, a golf ball with a high elasticity coefficient will compress upon impact and disperse that energy relatively quickly by returning to its original shape and form, resulting in higher launch momentum and therefore, longer distance traveled.
c. Packaging: Elastic polymers are often used in packaging to create stretch wraps or films, which can be stretched around a stack of items or containers; a resistance to stretching by the film creates a tight and secure seal and hold.
d. Medical devices: Medical devices and consumables such as gloves, catheters and stents are made from these types of polymers as they can conform to the shape of the body to provide support.

Overall, the elasticity of a polymer is an important factor to consider in a variety of applications, as it not only affects the performance and durability but also the functionality of the final product. However, most thermoplastic polymers or thermoplastic polymer blends with excellent elasticity do not typically exhibit rubber-like “recovery” or force recovery properties; they are significantly limited in recovering the original shape and property when strained and released. Likewise, the majority are synthesized from petroleum sources with few produced from bio-based and biodegradable materials.

Biodegradable polymers, or biopolymers, typically do not exhibit this rubber-like property, which restricts utilization in many applications that require some amount of elasticity. Hence, research into modifying biopolymers has garnered a lot of interest in improving ductility. However, no investigation has been reported on the recovery property. The blending of two or more biopolymers has become a popular and effective method to improve mechanical performance. This provides an opportunity to harness the desired properties of the individual polymers. Most biopolymers have very poor ductility, which limits the application scopes. Hence, researchers all over the world have focused on ways to impart ductility, elasticity and flexibility to those biopolymers while maintaining biodegradability.

Blending biodegradable thermoplastic polyesters with other petroleum-based polymers can achieve these properties but are detrimental to biodegradation in most scenarios. Hence, these blends with petroleum-based polymers are not viable or an option for achieving a biodegradable composition with recovery. Therefore, biodegradable additives blended with biodegradable/compostable polymers provide a pathway to achieving biodegradable composition with recovery. To the best of our knowledge, no literature describes the ability of bio-based and/or biodegradable polymers to achieve “force recovery” after being stretched to a significant percentage of its original length. Furthermore, there is no literature or patent on the development of resins for the production of films and injection molded parts with this property.

Elastomers and thermoplastic elastomers exhibit “recovery” as the bulk molecular chains of these materials are able to return to the original state of conformation, disorder or entropy. However, such polymers are mostly non-biobased nor compostable with exceptions such as natural rubber which is biobased but not compostable. This has led to investigations into the development of bio-based and compostable elastomers over the last decade to substitute in part or whole, petroleum-based equivalents for their highly tunable structure and properties. Synthesized elastomers have been explored as additives in polymer and biopolymer blends as modifiers for impact resistance, toughness enhancers, wear and tear resistance, and friction properties. In reference to this invention, bio-based, biodegradable and compostable elastomers are employed as recovery modifiers for polymers and polymer blends due to their anisotropic, hyperbranched or amorphous molecular structure. This attribute imparts elasticity and repeated deformability to high degrees on the resin, while still able to return to its original shape and form.

These elastomers can be made from different building blocks. However, the most popular building blocks have been from bio-based polyols and diacids. Glycerol and dicarboxylic acids, a bio-based alcoholic moiety with three hydroxyl functional groups and an acidic moiety, respectively, are viable options for synthesis of branched elastomers for various applications. Glycerol-based elastomers can act as additives or modifiers in polymer/biopolymer formulations. Several studies involving synthesis methods, modifications, applications and investigating effects of blending of these bio-based elastomers with other polymers on mechanical properties have been done.

### SUMMARY OF THE INVENTION

The invention encompasses biodegradable thermoplastic polyester compositions that exhibit a range of force recovery properties with good mechanical properties required for various plastic applications.

In other embodiments, the invention encompasses a process for the synthesis of biodegradable polyester elastomers, as well as a process of melt blending the biodegradable thermoplastic polyesters, biodegradable polyester elastomers, and optionally other additives including, but not limited to, plasticizers, fillers, coupling agents, processing aids, compatibilizers, and initiators and combinations thereof. These ingredients can be blended in specific weight ratios to make biodegradable resin compositions with force recovery properties. The resin composition development can either be performed in one or multiple-stage processes, which encompasses different ingredient compositions and concentrations.

In certain embodiments, the resin development process extends the range of molecular weights of the different biodegradable thermoplastic polyesters that can be used and melt-blended at various weight ratios.

In other embodiments, the biodegradable polyester elastomer of the invention extends various degrees of crosslinking or gel content.

In one embodiment, the invention encompasses a composition comprising the following raw materials for preparing the biodegradable resin composition further include, in parts by mass (w/w) of about 10 to 99.99% of biodegradable thermoplastic polyesters such as polylactic acid (PLA), polycaprolactone (PCL), polybutylene succinate (PBS), polybutylene succinate adipate (PBSA), polybutylene succinate terephthalate (PBST), polybutylene adipate-co-terephthalate (PBAT), polyhydroxyalkanoates (PHAs), or combinations thereof. In various embodiments, the amount of the biodegradable thermoplastic polymer is about 10%, 12.5%, 15%, 17.5%, 20%, 22.5%, 25%, 27.5%, 30%, 32.5%, 35%, 37.5%, 40%, 42.5%, 45%, 47.5%, 50%, 52.5%, 55%, 57.5%, 60%, 62.5%, 65%, 67.5%, 70%, 72.5%, 75%, 77.5%, 80%, 82.5%, 85%, 87.5%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99%, 99.1%, 99.2%, 99.3%, 99.4%, 99.5%, 99.6%, 99.7%, 99.8%, 99.9%, or about 99.99%.

In one embodiment, the biodegradable resin further includes, in parts by mass (w/w) of about 0.01 to 80% of biodegradable polyester elastomer. In various embodiments, the amount of the biodegradable polyester elastomer is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, 30%, 32.5%, 35%, 37.5%, 40%, 42.5%, 45%, 47.5%, 50%, 52.5%, 55%, 57.5%, 60%, 62.5%, 65%, 67.5%, 70%, 72.5%, 75%, 77.5%, or about 80%.

In one embodiment, the biodegradable resin further include, in parts by mass (w/w) of about 0 to 40% of biodegradable plasticizer. In various embodiments, the amount of the plasticizer is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, 30%, 32.5%, 35%, 37.5%, or about 40%.

In various embodiments, the plasticizers encompass, but are not limited to, plant-based oils obtained from sources such as vegetables, nuts, grains, seeds, etc. Examples of such oils include, but are not limited to, corn oil, soybean oil, and glycerol. These plant-based oils can be used either in their virgin form or modified form (e.g., through epoxidation, carboxylation, hydroxylation, and amidation). Modified plant-based oils such as epoxidized soybean oil, epoxidized linseed oil, and a range of citrate plasticizers (e.g., acetyl tributyl citrate (ATBC), triethyl citrate (TEC), acetyl triethyl citrate (ATEC), tributyl citrate (TBC)), as well as isosorbide-type plasticizers, natural waxes, glycol, sugar alcohols (e.g. xylitol, sorbitol, lactitol, mannitol, erythritol, maltitol), isosorbide diester, and fatty acid methyl esters (FAME), are also encompassed.

In one embodiment, the biodegradable resin further includes, in parts by mass (w/w) of about 0 to 80% of biodegradable starch and/or modified starch. In various embodiments, the amount of the starch or modified starch is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, 30%, 32.5%, 35%, 37.5%, 40%, 42.5%, 45%, 47.5%, 50%, 52.5%, 55%, 57.5%, 60%, 62.5%, 65%, 67.5%, 70%, 72.5%, 75%, 77.5%, or about 80%.

The source of starch or modified starch includes, but is not limited to, cereal grains (e.g., corn, waxy corn, wheat, sorghum, rice, and waxy rice, which can also be used in the flour and cracked state), tubers of all types and nature such as potato, roots (tapioca for example cassava and manioc), sweet potato, and arrowroot, modified corn starch, and the pith of the sago palm. In various embodiments, these starches can be used either in their virgin or modified form (e.g., through epoxidation, carboxylation, hydroxylation, gelatinization, plasticization, and amidation). Among the raw materials for preparing the biodegradable resin, virgin and modified starches are also used as a substrate of the biodegradable plastics to increase the degradability, biobased content and most importantly, impart the recovery force property to the biopolymer resin. Optionally, the starch used as a filler and modified for use as a polymer is at least one selected from the group consisting of but not limited to corn starch, tapioca starch, rice starch, potato starch, wheat starch, rice starch weighed on a dry weight basis.

Among the raw materials for preparing the biodegradable resin composition, virgin starch and/or modified starch are also used. Optionally, the modified starch can be a product of at least one starch or its derivatives, including any known starch material. Preferred starches could include any starch from sources such as, but not limited to cereal grains (e.g, corn, waxy corn, wheat, sorghum, rice, and waxy rice, which can also be used in the flour and cracked state), tubers of all types and nature such as potato, roots (tapioca (i.e., cassava and manioc), sweet potato, and arrowroot, modified corn starch, and the pith of the sago palm. Other ingredients of the modified starch could contain at least one polyol including but not limited to sorbitol, mannitol, galactitol, xylitol, ribitol, arabitol, erythritol, glycerol, threitol and a derivative thereof, and at least one organic acid such as saturated or unsaturated dicarboxylic acid including but not limited to succinic acid, sebacic acid, glutaric acid, hexanedioic acid, heptanoic acid, octanedioic acid, nonanedioic acid, and decanoic acid or a derivative thereof, and combinations thereof and additives such as but not limited to water, crosslinkers, initiators, alkalizers, acidifiers, peroxides, coupling agents, fillers, compatibilizing agents, pigments and combinations thereof.

In one embodiment, the biodegradable resin further includes in parts by mass (w/w) of about 0 to 10% of an organic acid compatibilizer such as, but not limited to lactic acid, formic acid, stearic acid, tannic acid, malic acid, citric acid, aspartic acid, ascorbic acid, acetic acid, tartaric acid, or combinations thereof. In various embodiments, the amount of the organic acid compatibilizer is about 0%, 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, or 10%.

In one embodiment, the biodegradable resin further includes, in parts by mass (w/w) of about 0 to 10% of coupling agents which encompasses both long and short-chain hydrocarbons with functional groups such as but no limited to epoxides, hydroxyls, anhydrides, peroxides and citrates. In various embodiments, the amount of the one or more coupling agents is about 0%, 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, or 10%.

In one embodiment, the biodegradable resin further include, in parts by mass (w/w) of about 0 to 20% of fillers which encompasses both inorganic and biomass fillers and a combination thereof. In various embodiments, the amount of the fillers is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, or about 20%.

In certain embodiments, the composition could further include, in parts by mass (w/w) of about 0 to 10% of compatibilizers, chain extenders, peroxides, initiators, pigments, cross-linkers, or a combination thereof. In various embodiments, the amount of the one or more compatibilizers, chain extenders, peroxides, initiators, pigments, cross-linkers, or a combination thereof is about 0%, 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, or 10%.

In one embodiment, the biodegradable polyester elastomer synthesis includes a polyol encompassing but not limited to sorbitol, mannitol, galactitol, xylitol, ribitol, arabitol, erythritol, glycerol, threitol, and derivatives thereof, and an organic acid such as saturated or unsaturated dicarboxylic acid including, but not limited to, succinic acid, sebacic acid, glutaric acid, hexanedioic acid, heptanoic acid, octanedioic acid, nonanedioic acid, and decanoic acid or derivatives thereof. The molar ratio of polyol to dicarboxylic acid is in the range of about 0.32, 0.7, 0.8, 0.9, and 1.28.

In certain embodiments, the method for the production of the biodegradable polyester elastomer can be any of the following but not limited to the use of at least a polyol, an organic acid, and optionally other additives including, but not limited to, plasticizer, initiator, filler, compatibilizer, etc. In various embodiments, the polyol to organic acid molar ratio, ranging from about 0.32 to about 1.28 is employed. In various embodiments, the ratio is of the polyol to organic acid is about 0.25, 0.30, 0.35, 0.40, 0.45, 0.5, 0.55, 0.60, 0.65, 0.7, 0.75, 0.8, 0.85, 0.9, 0.95, 1.00, 1.05, 1.1, 1.15, 1.2, 1.25, 1.30, 1.35, 1.40 1.45, or about 1.5.

In one embodiment, the reactants are premixed in a reaction vessel and then raised to a desired temperature. In another scenario, the organic acid is melted before the addition of polyol and other optional additives under stirring in a reaction vessel. In another scenario, the polyol and other optional additives are premixed prior to the addition of an organic acid. In another scenario, the organic acid and polyol are mixed and heated to a specific temperature before the addition of any other optional additives.

In certain embodiments, the reaction vessel could be made of heat and crack-resistant glassware, stainless steel or high-temperature-resistant plastic, equipped with an overhead stirrer. The temperature of the mixtures is increased to the desired reaction temperature and maintained throughout the reaction. The reaction is cooled slowly or rapidly and considered complete after a period ranging from a few minutes to a few hours.

In certain embodiments, the reaction is set at temperatures ranging from 100 to 250° C. Reagents are agitated from the point of mixture and at room temperature. In another scenario, the agitation is started after the reagents are melted. The reaction is continued until the desired consistency of the elastomer is achieved. In one scenario, agitation is continued after achieving the desired consistency of elastomer for a period ranging from about 1 minute to a few hours. In another scenario, the agitation is increased or decreased after achieving the desired consistency of elastomer. In another scenario, agitation is stopped after achieving the desired consistency of elastomer.

In certain embodiments, the resin is a combination of any of the following biodegradable thermoplastic polyesters and/or elastomers: polylactic acid, polycaprolactone, polybutylene succinate, polybutylene succinate adipate, polybutylene succinate terephthalate, polybutylene adipate-co-terephthalate, polyhydroxyalkanoates, and/or one or more biodegradable polyester elastomers.

In one embodiment, the polymer is a mixture of polylactic acid and polybutylene adipate terephthalate and one or more biodegradable polyester elastomers.

In one embodiment, the polymer is a mixture of polylactic acid, polycaprolactone and one or more biodegradable polyester elastomers.

In one embodiment, the polymer is a mixture of polylactic acid and polybutylene succinate and one or more biodegradable polyester elastomers.

In one embodiment, the polymer is a mixture of polylactic acid and polycaprolactone and one or more biodegradable polyester elastomers.

In one embodiment, the polymer is a mixture of polylactic acid and one or more biodegradable polyester elastomers.

In one embodiment, the polymer is a mixture of one or more biodegradable polyester elastomers and polybutylene adipate-co-terephthalate.

In one embodiment, the polymer is a mixture of polylactic acid, one or more biodegradable polyester elastomers, polyhydroxyalkanoate and polybutylene succinate.

In one embodiment, the polymer is a mixture of one or more biodegradable polyester elastomers and polyhydroxyalkanoate.

In one embodiment, the polymer is a mixture of polylactic acid, one or more biodegradable polyester elastomers and polyhydroxyalkanoate.

In one embodiment, the polymer is a mixture of polybutyleneadipate-co-terephthalate, elastomer and polyhydroxyalkanoate.

The embodiments are not limited to binary combinations of biodegradable thermoplastic polyesters and biodegradable polyester elastomers, but could encompass combinations of three or more of the thermoplastic polyesters and the elastomers.

In certain embodiments, the biomass filler material can include, but not limited to distillers' grains, vinasse, vinegar residues, wood fiber, grains, agricultural cellulosic matter from including but not limited to straw, stalk, shive, hurd, bast, leaf, seed, fruit, and perennial grass, all in a non-continuous non-woven form including chopped pieces, particulates, dust or flour.

In other embodiments, the invention encompasses a method for preparing the biodegradable resin composition comprising the following steps:
a. mixing of all the biodegradable thermoplastic polyesters and elastomers by means of a batch mixer or an extruder for a prescribed time period at a temperature higher than ambient temperatures to prepare a uniform melt,
b. mixing of additives such as plasticizers, compatibilizers and fillers to the polymer melt for another prescribed period of time to make the final resin.

In other embodiments, the invention encompasses a method for preparing the biodegradable resin composition comprising the following steps:
a. mixing of all the biodegradable thermoplastic polyesters and plasticizers by means of a batch mixer or an extruder for a prescribed time period at a temperature higher than ambient temperatures to prepare a uniform polymer melt,
b. mixing of elastomers and other optional additives such as compatibilizers and fillers to the polymer melt for another prescribed period of time to make the final resin.

In other embodiments, the invention encompasses a method for preparing the biodegradable resin composition comprising the following steps:
a. mixing of all the elastomers and plasticizers by means of a batch mixer or an extruder for a prescribed time period at a temperature higher than ambient temperatures to prepare a uniform polymer melt,
b. mixing of biodegradable thermoplastic polyesters and other optional additives such as compatibilizers and fillers to the polymer melt for another prescribed period of time to make the final resin.

The order of adding ingredients is not limited to the aforementioned methods and could include any other orders and combinations.

In certain embodiments, the method further comprises forming any articles in any shape and rigidity using conventional polymer processing techniques such as thermoforming, hot press, vacuum forming, cast extrusion, film blowing, injection molding or compression molding.

In one embodiment, the process of producing the resin formulation includes extrusion, where the extrudate is formed at a temperature above ambient temperature, preferably in a range of 50 to 250° C.

In certain embodiments, the invention encompasses a disposable product, comprising the biodegradable composition, wherein the disposable product is a packing material or a consumer product.

In certain embodiments, the biodegradable compositions of the invention can be used in various embodiments from single-use products to durable products and in a wide range of applications, from packaging to medical, consumer products and many more.

In certain embodiments, the composition exhibits a bio-based carbon content of up to 100%.

In certain embodiments, the composition exhibits an MFI (melt flow index) of as low as 0.3 and as high as 55 g/10 min at about 190° C.

In certain embodiments, the composition exhibits a force recovery of more than 6% in machine direction of a cast extruded film, after an initial strain of 20% was applied at a rate of 500 mm/min and then reduced to a strain of 6% at a rate of 500 mm/min and held constant for 12 seconds.

In certain embodiments, the composition exhibits a force recovery of more than 6% in transverse direction of a cast extruded film, after an initial strain of 20% was applied at a rate of 500 mm/min and then reduced to a strain of 6% at a rate of 500 mm/min and held constant for 12 seconds.

In certain embodiments, the composition exhibits a force recovery of more than 9% in machine direction of a cast extruded film, after an initial strain of 30% was applied at a rate of 500 mm/min and then reduced to a strain of 9% at a rate of 500 mm/min and held constant for 12 seconds.

In certain embodiments, the composition exhibits a force recovery of more than 7% in transverse direction of a cast extruded film, after an initial strain of 30% was applied at a rate of 500 mm/min and then reduced to a strain of 9% at a rate of 500 mm/min and held constant for 12 seconds.

In various embodiments, the invention encompasses biodegradable resin composition comprising:
a. about 10 to about 99.99% (w/w) of one or more biodegradable thermoplastic polymers;
b. about 0.01 to about 80% (w/w) of one or more biodegradable polyester elastomers;
c. about 0 to about 40% (w/w) of one or more plasticizers;
d. about 0 to about 80% (w/w) of one or more biodegradable modified starches;
e. about 0 to about 20% (w/w) of one or more of inorganic fillers;
f. about 0 to about 20% (w/w) of one or more of biomass fillers; and
g. about 0 to about 10% (w/w) of one or more of additives such as coupling agents, processing aids, compatibilizing agents, chain extenders, initiators, peroxides, impact modifiers and pigments.

In certain embodiments, the composition exhibits force recovery property shortly after being stretched to a certain strain and then returned to a lower strain and held for a period of time.

In certain embodiments, the composition comprises a minimum of about 5% force recovery within about 60 seconds, while being held at a holding strain of at least about 5% after returning from an initial strain of at least about 10% that falls beyond the elastic region on the tensile stress-strain curve of the resin composition.

In certain embodiments, the strain rate to stretch to the initial strain and to return to the holding strain is about 0.1 to about 1500 mm/min.

In certain embodiments, the percentage of the recovered force is measured with respect to the maximum force causing the initial strain.

In certain embodiments, the biodegradable thermoplastic polymer is selected from the group consisting of biodegradable thermoplastic polyesters comprising polylactic acid, polycaprolactone, polybutylene succinate, polybutylene succinate adipate, polybutylene succinate terephthalate, polybutylene adipate-co-terephthalate, polyhydroxyalkanoates, and combinations thereof.

In certain embodiments, the biodegradable polyester elastomer is a synthesized product of at least one polyol selected from the group consisting of sorbitol, mannitol, galactitol, xylitol, ribitol, arabitol, erythritol, glycerol, threitol and combinations thereof, and at least one organic acid selected from saturated or unsaturated dicarboxylic acid comprising to succinic acid, sebacic acid, glutaric acid, hexanedioic acid, heptanoic acid, octanedioic acid, nonanedioic acid, and decanoic acid or combinations thereof.

In certain embodiments, the molar ratio of the polyol to the organic acid is about 0.32 to about 1.28.

In certain embodiments, the biodegradable modified starch is selected from the group consisting of oxidized starch, esterified starch, plasticized starch, thermoplastic starch, hydrophilicized starch, hydrophobicized starch, and enzyme-treated starch.

In certain embodiments, the plasticizers comprise one or more plant-based oils obtained from sources such as vegetables, nuts, grains, seeds, etc. Examples of such oils include, but are not limited to, corn oil, soybean oil, and glycerol. These plant-based oils can be used either in their virgin form or after modification (e.g., through epoxidation, carboxylation, hydroxylation, and amidation). Modified plant-based oils such as epoxidized soybean oil, epoxidized linseed oil, and a range of citrate plasticizers (e.g., acetyl tributyl citrate (ATBC), triethyl citrate (TEC), acetyl triethyl citrate (ATEC), tributyl citrate (TBC)), as well as isosorbide-type plasticizers, natural waxes, glycol, sugar alcohols (e.g. xylitol, sorbitol, lactitol, mannitol, erythritol, maltitol), isosorbide diester, and fatty acid methyl esters (FAME) are also encompassed.

In certain embodiments, the inorganic fillers include, but are not limited to, wollastonite, mica, clay, calcium carbonate, glass fiber, talc, aluminum silicate, zirconium oxide, sepiolite, gypsum and a combination thereof.

In certain embodiments, the biomass comprises distillers' grains, vinasse, vinegar residues, wood fiber, virgin starch, modified starch, grains, agricultural cellulosic matter including but not limited to straw, stalk, shive, hurd, bast, leaf, seed, fruit, and perennial grass, all in a non-continuous non-woven form, which may consist of chopped pieces, particulates, dust, or flour or a combination thereof.

In certain embodiments, the composition exhibits 10%, 20%, 30%, 40%, 50%, 60%, 70%, 80%, or 90% disintegration completion within about 180 to about 365 days at ambient temperature.

In certain embodiments, the composition exhibits 10%, 20%, 30%, 40%, 50%, 60%, 70%, 80%, or 90% disintegration completion within about 180 to about 365 days in soil at ambient temperature.

In certain embodiments, the composition exhibits more than 90% disintegration in less than 30, 35, 40, 45, 50, 55, 60, 65, 70, 75, 80, 81, 82, 83, 84, 85, 86, 87, 88, 89, or 90 days.

In certain embodiments, the composition exhibits more than 90% biodegradation in less than 90, 100, 110, 120, 130, 140, 150, 160, 170, 175, or 180 days.

In certain embodiments, the composition exhibits more than 90% disintegration in less than 30, 35, 40, 45, 50, 55, 60, 65, 70, 75, 80, 81, 82, 83, 84, 85, 86, 87, 88, 89, or 90 days under thermophilic temperature conditions.

In certain embodiments, the composition exhibits more than 90% biodegradation in less than 90, 100, 110, 120, 130, 140, 150, 160, 170, 175, or 180 days under thermophilic temperature conditions.

In certain embodiments, the biodegradable polyester elastomer is produced by reacting the ingredients at a temperature ranging from about 100 to about 250° C., continuing the reaction until the desired texture of the elastomer is achieved.

In certain embodiments, the invention encompasses methods of producing the biodegradable resin composition in which ingredients are mixed and melt-compounded together in a polymer processing equipment or apparatus selected from a batch mixer, a twin screw extruder or a single screw extruder, at elevated temperatures for a time period of several seconds to several minutes.

In certain embodiments, the bio-based carbon content of the composition is up to 100%.

In certain embodiments, the bio-based carbon content of the biodegradable polyester elastomer is up to 100%.

In certain embodiments, the biodegradable resin composition is for use in consumer articles of any thickness and rigidity made by conventional polymer processing techniques comprising blown and cast film extrusion, compression molding and injection molding techniques.

### DETAILED DESCRIPTION OF THE INVENTION

To facilitate an understanding of the invention, it will be described more comprehensively herein below. However, the invention may be embodied in different forms and is not limited to the embodiments set forth herein. Rather, these embodiments are provided for the purpose of making the disclosure of the invention more thorough and comprehensive.

Unless otherwise defined, all technical and scientific terms used herein have the same meaning as those commonly understood by a person skilled in the art to which the present invention belongs. Terms used in the specification of the present invention are only for the purpose of describing specific embodiments, and are not intended to limit the present invention.

### Definitions

The term “biodegradable polyester elastomer” is herein defined to refer to an elastomer synthesized from polyol(s) and a dicarboxylic organic acid(s) that could further include other additives.

The term “biobased” or “bio-based” refers to compositions that are derived from plant matter instead of being made from petroleum or natural gas. Because they are plant-based, there is a tendency to assume that the type of plastic must be biodegradable. However, this is not the case for all plant-based compositions. The bio-based compositions of the invention can be designed to biodegrade in less than 6 months.

The term “thermoplastic”, as used herein, refers to a polymer, which softens when heated and becomes moldable and pliable then hardens when cooled.

The prefix “bio” as used herein refers to a material that has been derived from a renewable biological resource.

The terms “blend” and “resin” as used herein interchangeably, refer to a homogeneous mixture of two or more different polymers and elastomers along with other ingredients.

The term “machine direction” or “MD” refers to the direction parallel to the pull of an extruded polymer film from the die during a cast extrusion process.

The term “transverse direction” or “TD” refers to the direction perpendicular to the pull of an extruded polymer film from the die during a cast extrusion process.

The term “biodegradable” refers to compositions of the invention that can biodegrade within 12 months in a compost environment in a non-toxic, environmentally compatible manner with no heavy metal nor PTFE content, and remaining soil-safe (i.e., lack of eco-toxins). The compositions of the invention biodegrade within 12 months. Compostable plastic is biodegradable, but not every plastic that is biodegradable is compostable. The compositions of the invention are both biodegradable and compostable. As used herein, “biodegradable” compositions are engineered to biodegrade in compost, soil, or water. In particular, biodegradable plastics are plastics with innovative molecular structures that can be decomposed by bacteria at the end of their life under certain environmental conditions.

The term “bioplastics” or “biopolymer” is used to refer to plastics that are bio-based, biodegradable, or fit both criteria. Bio-based plastics of the invention are fully or partly made from renewable feedstock derived from biomass. Commonly used raw materials to produce these renewable feedstock for plastic production include, but are not limited to, corn starch, corn stalks, sugarcane stems, cellulose, and various oils and fats from renewable sources.

The term “modified starch” is herein defined as starch that is transformed from its native form by typical processes known in the art including, physical, physiochemical, biological, biochemical or chemical processes such as, for example, plasticization, gelatinization, esterification, etherification, oxidation, acid hydrolysis, cross-linking, and enzyme conversion. Typical starch or modified starches include esters, such as the acetate and, the half-esters of dicarboxylic acids/anhydrides, particularly the alkenyl succinic acids/anhydrides; ethers, such as the hydroxyethyl and hydroxypropyl starches; oxidized starches, such as those oxidized with hypochlorite; starches reacted with cross-linking agents, such as phosphorus oxychloride, epichlorohydrin, hydrophobic cationic epoxides, and phosphate derivatives prepared by reaction with sodium or potassium orthophosphate or tripolyphosphate, and combinations thereof. Preferred starches can include any starch or modified starch that is initially in a native state as a granular solid, and obtained from sources such as, but not limited to cereal grains (e.g, corn, waxy corn, wheat, sorghum, rice, and waxy rice, which can also be used in the flour and cracked state), tubers of all types and nature such as potato, roots (tapioca (i.e., cassava and manioc), sweet potato, and arrowroot, modified corn starch, and the pith of the sago palm. Other ingredients of the modified starch could contain at least one polyol including but not limited to sorbitol, mannitol, galactitol, xylitol, ribitol, arabitol, erythritol, glycerol, threitol and a derivative thereof, and at least one organic acid such as saturated or unsaturated dicarboxylic acid including but not limited to succinic acid, sebacic acid, glutaric acid, hexanedioic acid, heptanoic acid, octanedioic acid, nonanedioic acid, and decanoic acid or a derivative thereof, and additives such as but not limited to water, crosslinkers, initiators, alkalizers, acidifiers, peroxides, coupling agents, fillers, compatibilizing agents, pigments and combinations thereof.

The term “thermoplastic starch (TPS)” is herein defined to refer to thermoplastic polymers produced from one or more starch that has been gelatinized or plasticized in the presence of heat above ambient temperature and shear, using ingredients such as but not limited to one or more polyols, organic acids and additives such as but not limited to water, crosslinkers, initiators, alkalizers, acidifiers, peroxides, coupling agents, fillers, compatibilizing agents, pigments and combinations thereof.

As used herein, “compostable” compositions refer to biodegradation into soil conditioning material (i.e., compost). In order for a plastic to be labeled as commercially “compostable” it should be broken down by biological treatment at an industrial composting facility in 180 days or less. Composting utilizes microorganisms, agitation, heat, and humidity to yield carbon dioxide, water, inorganic compounds, and biomass that is similar in characteristic to the rest of the finished compost product. Decomposition of the composition should occur at a rate similar to the other elements of the material being composted (e.g., within 6 months) and leave no toxic residue that would adversely impact the ability of the finished compost to support plant growth. ASTM Standards D6400 and D6868 outline the specifications that must be met in order to label a plastic as “industrial compostable”.

The term “disintegration” refers to a plastic product that leaves no more than 10% of its original dry weight after twelve weeks (84 days) in a controlled thermophilic composting test and sieved through a 2.0-mm mesh.

The term “polyesters” refers to polymers of the invention that are obtained, for example, by aliphatic diols, aliphatic dicarboxylic acids, and aromatic dicarboxylic acids/esters. The term polyesters also includes aliphatic-aromatic polyesters. The biodegradable thermoplastic polyesters of the current invention include but are not limited to: polylactic acid (PLA) or poly(lactic acid) (PLA); polycaprolactone (PCL); poly(butylene succinate) (PBS) or polybutylene succinate (PBS); poly(butylene succinate adipate) (PBSA), polybutylene succinate adipate (PBSA), poly(butylene succinate-co-adipate) (PBSA), polybutylene succinate-co-adipate (PBSA), poly(butylene succinate-co-butylene adipate) (PBSA) or polybutylene succinate-co-butylene adipate (PBSA); poly(butylene succinate terephthalate) (PBST), polybutylene succinate terephthalate (PBST), poly(butylene succinate-co-terephthalate) (PBST), polybutylene succinate-co-terephthalate (PBST), poly(butylene succinate-co-butylene terephthalate) (PBST) or polybutylene succinate-co-butylene terephthalate (PBST); poly(butylene adipate terephthalate) (PBAT), polybutylene adipate terephthalate (PBAT), poly(butylene adipate-co-terephthalate) (PBAT), polybutylene adipate-co-terephthalate (PBAT), poly(butylene adipate-co-butylene terephthalate) (PBAT) or polybutylene adipate-co-butylene terephthalate (PBAT); and polyhydroxyalkanoates (PHAs).

As used herein, “recovery” or “force recovery” refers to the ability of the material (resin composition developed herein) to recover a percentage of its strength within its plastic region, within a specified time frame. The force recovery can be measured using testing equipment such as a universal testing machine (UTM) via the following procedure:

The material is first stretched to an “initial strain” beyond the elastic region on its tensile stress-strain curve, at a specific strain rate. At this strain, the “maximum force” is recorded. Following this, the sample is returned from its initial strain to a “holding strain”, at a specific strain rate, and held at this holding strain for a specific period of time referred to as the “holding time”. The final step involves measuring the percentage of the force recovered relative to the “maximum force” recorded, which is then reported as the force recovery of the composition.

As used herein, “additive” could refer to material used to enhance a targeted property or function of material and/or composition, which could be in any form such as solid, liquid, powder, fiber, or crystal.

The term polyhydroxyalkanoates (PHAs) refers to a family of bio-based thermoplastic polyesters synthesized by various microorganisms, particularly through bacterial fermentation. The PHA family encompasses over 150 different monomers, allowing for the production of materials with a wide range of properties. Notably, these plastics are biodegradable and include, but are not limited to, poly-3-hydroxybutyrate (PHB), polyhydroxybutyrate-co-hydroxyvalerate (PHBV), poly-4-hydroxybutyrate (P4HB), polyhydroxybutyrate-co-hydroxyhexanoate (PHBH), polyhydroxyvalerate (PHV), polyhydroxyhexanoate (PHH), polyhydroxyoctanoate (PHO), polyhydroxydecanoate (PHD), and polyhydroxydodecanoate (PHDD).

As used herein, “wt. %”, “parts by mass (w/w)” or “parts by mass % (w/w)” refer to the percentage weight of an ingredient with respect to the total weight of a composition.

### Ingredient of the Invention

The present invention is concerned with the development of biodegradable thermoplastic resin compositions that exhibit force recovery properties. In general, the biodegradable compositions of the invention can be considered valid alternative materials to those produced from petroleum resources.

The biodegradable polymers of the biodegradable resin composition can be derived from natural resources. In certain embodiments, the biodegradable polymers of the invention include biodegradable thermoplastic polyesters.

In certain embodiments, the biodegradable thermoplastic polyester includes, but is not limited to, one or more of polylactic acid, polycaprolactone, polybutylene succinate, polybutylene succinate adipate, polybutylene succinate terephthalate, polybutylene adipate terephthalate, polyhydroxyalkanoates or combinations thereof.

The embodiment compositions may include, but are not limited to, any of the following polymer combinations:

In certain embodiments, the biodegradable thermoplastic polyesters include polylactic acid and polycaprolactone.

In certain embodiments, the biodegradable thermoplastic polyesters include polylactic acid and polybutylene succinate.

In certain embodiments, the biodegradable thermoplastic polyesters include polylactic acid and polybutylene succinate adipate.

In certain embodiments, the biodegradable thermoplastic polyesters include polylactic acid and polybutylene succinate terephthalate.

In certain embodiments, the biodegradable thermoplastic polyesters include polylactic acid and polybutylene adipate terephthalate.

In certain embodiments, the biodegradable thermoplastic polyesters include polylactic acid and polyhydroxyalkanoates.

In certain embodiments, the biodegradable thermoplastic polyesters include polycaprolactone and polybutylene succinate.

In certain embodiments, the biodegradable thermoplastic polyesters include polycaprolactone and polybutylene succinate adipate.

In certain embodiments, the biodegradable thermoplastic polyesters include polycaprolactone and polybutylene succinate terephthalate.

In certain embodiments, the biodegradable thermoplastic polyesters include polycaprolactone and polybutylene adipate terephthalate.

In certain embodiments, the biodegradable thermoplastic polyesters include polycaprolactone and polyhydroxyalkanoates.

In certain embodiments, the biodegradable thermoplastic polyesters include polybutylene succinate and polybutylene succinate adipate.

In certain embodiments, the biodegradable thermoplastic polyesters include polybutylene succinate and polybutylene succinate terephthalate.

In certain embodiments, the biodegradable thermoplastic polyesters include polybutylene succinate and polybutylene adipate terephthalate.

In certain embodiments, the biodegradable thermoplastic polyesters include polybutylene succinate and polyhydroxyalkanoates.

In certain embodiments, the biodegradable thermoplastic polyesters include polybutylene succinate adipate and polybutylene succinate terephthalate.

In certain embodiments, the biodegradable thermoplastic polyesters include polybutylene succinate adipate and polybutylene adipate terephthalate.

In certain embodiments, the biodegradable thermoplastic polyesters include polybutylene succinate adipate and polyhydroxyalkanoates.

In certain embodiments, the biodegradable thermoplastic polyesters include polybutylene succinate terephthalate and polybutylene adipate terephthalate.

In certain embodiments, the biodegradable thermoplastic polyesters include polybutylene succinate terephthalate and polyhydroxyalkanoates.

The abovementioned embodiments are not limited to binary combinations of biodegradable thermoplastic polyesters, but could encompass combinations of three or more biodegradable thermoplastic polyesters.

In certain embodiments, the biodegradable resin composition can further include any form of modified starch which can include but is not limited to modified starch, oxidized starch, esterified starch, plasticized starch including TPS, hydrophilicized starch, hydrophobicized starch and enzyme-treated starch.

The biodegradable resin compositions include a biodegradable polyester elastomer. The biodegradable polyester elastomers of the biodegradable resin composition mainly consist of the use of a polyol such as pure sorbitol, mannitol, galactitol, xylitol, ribitol, arabitol, erythritol, glycerol, threitol or a derivative thereof and an organic acid such as saturated or unsaturated dicarboxylic acid including but not limited to succinic acid, sebacic acid, glutaric acid, hexanedioic acid, heptanoic acid, octanedioic acid, nonanedioic acid, and decanoic acid or a derivative thereof as the reactants for this invention. The polyols and organic acids can be sourced from fully bio-based, partially bio-based, non-bio-based sources, or a combination thereof. The molar ratio of polyol to dicarboxylic acid could encompass a range from about 0.32 to about 1.28. Optionally, other additives including but not limited to plasticizer, initiator, filler, compatibilizer, etc. could be added to the synthesis.

These biodegradable polyester elastomers include, but are not limited to, polyglycerol azelate (PGAz), polyglycerol sebacate (PGS), polyglycerol adipate (PGAd), polyglycerol succinate (PGSu), polyglycerol malonate (PGMa), poly(mannitol sebacate) (PMSe), poly(xylitol succinate) (PXSu), poly(erythritol-co-dicarboxylate) (PErD), poly(erythritol-co-adipate) (PErAd), poly(erythritol-co-pimelate) (PErPi), poly(erythritol-co-suberate) (PErSu), poly(erythritol-co-azelate) (PErAz) poly(erythritol-co-sebacate) (PErSe), poly(erythritol-co-dodecanedioate) (PErDo), poly(erythritol tetradecanedioate) (PErMyr), poly(xylitol-co-sebacate) (PXS), poly(sorbitol adipate) (PSA), poly(sorbitol-co-sebacate) (PSS), poly(sorbitol-co-citrate-co-sebacate) (PSCS), poly(sorbitol-co-tartaric-co-sebacate) (PSTS), poly(sorbitol-co-azelate) (PSAz), poly(maltitol-co-adipate) (PMaAd), and poly(maltitol-co-suberate) (PMaS).

In various embodiments, the methods for the production of the biodegradable polyester elastomer comprise:

In one embodiment, the reactants are mixed together in a reaction vessel and heated to a desired temperature for a certain period of time. In another embodiment, the organic acid is melted prior to the addition of polyol and other optional additives under stirring in a vessel. In another embodiment, the polyol and other optional additives are premixed and heated to a desired temperature before the addition of the organic acid. In another embodiment, the organic acid and polyol are premixed and heated to a desired temperature prior to the addition of any other optional additives.

In another embodiment, the reaction vessel is made of heat and crack-resistant glassware, stainless steel, or high-temperature-resistant plastic equipped with an overhead stirrer or another mechanism for the agitation of the reagents. The temperature of the mixture is increased to the desired reaction temperature and maintained throughout the reaction. The reaction is cooled rapidly or slowly to ambient temperature and considered complete after a time period that could range from a few minutes to a few hours.

In certain embodiments, the reaction is set at elevated temperatures ranging from about 100 to about 250° C. Reagents are agitated from the point of mixture and at room temperature. In another scenario, the agitation is started after the reagents are melted. The reaction is continued until the desired consistency of the elastomer is achieved. In one embodiment, agitation is continued after achieving the desired consistency of elastomer for a time period ranging from a few minutes to a few hours. In another embodiment, the agitation is increased or decreased after achieving the desired consistency of elastomer. In another embodiment, agitation is stopped after achieving the desired consistency of the elastomer.

In certain embodiments, the plasticizers of the biodegradable resin composition of the invention include, but are not limited to, at least one or more plant-based oils obtained from sources such as vegetables, nuts, grains, seeds, etc. Examples of such oils include, but are not limited to, corn oil, soybean oil, and glycerol. These plant-based oils can be used either in their virgin form or after modification (e.g., through epoxidation, carboxylation, hydroxylation, and amidation). Modified plant-based oils such as epoxidized soybean oil, epoxidized linseed oil, and a range of citrate plasticizers (e.g., acetyl tributyl citrate (ATBC), triethyl citrate (TEC), acetyl triethyl citrate (ATEC), tributyl citrate (TBC)), as well as isosorbide-type plasticizers, natural waxes, glycol, sugar alcohols (e.g. xylitol, sorbitol, lactitol, mannitol, erythritol, maltitol), isosorbide diester, and fatty acid methyl esters (FAME) are also encompassed.

In certain embodiments, the biodegradable resin compositions can optionally further include inorganic fillers including but not limited to, wollastonite, mica, clay, calcium carbonate, glass fiber, talc, aluminum silicate, zirconium oxide, sepiolite, and gypsum.

In certain embodiments, the biodegradable resin compositions can optionally further include biomass fillers and organic fillers including but not limited to, distillers' grains, vinasse, vinegar residues, wood fiber, virgin starch, grains, agricultural cellulosic matter from including but not limited to straw, stalk, shive, hurd, bast, leaf, seed, fruit, and perennial grass, all in a non-continuous non-woven form including chopped pieces, particulates, dust or flour, virgin starch and modified starch. The starch used as a filler is at least one selected from the group consisting of but not limited to corn starch, potato starch, wheat starch and rice starch, measured on a dry weight basis.

In certain embodiments, the biodegradable resin composition can optionally further include additives such as but not limited to crosslinkers, initiators, peroxides, coupling agents, fillers, compatibilizing agents, processing aids, pigments and chain extenders.

In certain embodiments, the biodegradable resin composition comprises about 10 to about 99.99% (w/w) of one or more biodegradable thermoplastic polymers; about 0.01 to about 80% (w/w) of one or more biodegradable polyester elastomers; about 0 to about 40% (w/w) of one or more plasticizers; about 0 to about 80% (w/w) of one or more biodegradable modified starches; about 0 to about 20% (w/w) of one or more of inorganic fillers; about 0 to about 20% (w/w) of one or more of biomass fillers; about 0 to about 10% (w/w) of one or more of additives such as coupling agents, compatibilizing agents, chain extenders, processing aids, pigments, initiators, peroxides, impact modifiers and pigments.

### Biodegradable Resin Composition Production

In certain embodiments, the ingredients may be processed together in various scenarios. In one scenario, all ingredients are premixed and melt-processed together. In another scenario, the biodegradable polymer(s) will be plasticized and then melt-processed with the biodegradable elastomer and other additives. In yet another scenario, all or one of the biodegradable polymer(s) will be melt-processed, followed by the addition of the biodegradable elastomer, and subsequently, the other biopolymer(s) and additives. Alternatively, the biodegradable polymer(s) may be initially partially plasticized with a portion of the plasticizer(s) used and thereafter, the addition of the biodegradable elastomer, and other additives along with the rest of the plasticizer(s). Furthermore, the additives may be added to the biodegradable polymer(s) before the addition of the biodegradable elastomer(s). In yet another scenario, only one of the biodegradable biopolymers is initially melt-processed with the biodegradable elastomer and a portion of the additives, before subsequently melt-processing with the rest of the additives and other biodegradable biopolymers. The blending or processing of the ingredients are not limited to the aforementioned scenarios but may include all possible ingredient combination scenarios.

In certain embodiments, the blending of the aforementioned ingredients may be achieved using mixing and melt-compounding equipment with adjustable and controllable temperatures and mixing speeds, such as a single or twin screw extruder or a batch kneader. In a batch kneader, the processing temperature profile may range from about 50 to about 250° C., and the processing time may be between about 1 to about 60 minutes. Alternatively, in embodiments where single or twin screw extrusion is employed, the temperature profile may range from about 50 to about 250° C., and the screw speed may range from about 50 to about 500 rpm. It should be noted that the processing conditions provided herein are not limiting and may vary based on other conditions such as ingredient ratios and processing equipment. The resulting product may be formed into films, sheets or more rigid parts using conventional cast extrusion, blown film extrusion, injection molding or compression molding techniques. Alternatively, the resulting product may be pelletized or crushed into powder and then injection molded or compression molded into plastic parts of higher thicknesses. The extrusion, injection or compression temperature is typically within the range used in the melt-processing and compounding of the resins and ingredients.

### Force Recovery Measurement Test Method

In certain embodiments, the force recovery can be measured using a universal testing machine (UTM) via different methods including but not limited to the following:

Testing can be conducted using a sample size specified by ASTM D882, measuring 2 cm in width and 15 cm in length. This includes a 10 cm testing area and 2.5 cm on each side reserved for gripping.
(i) The sample is stretched to an “initial strain” of at least 10% that falls beyond the elastic region on the tensile stress-strain curve, with a strain rate between 0.1 to 1500 mm/min.
(ii) The “maximum force” that causes this strain is recorded.
(iii) The sample is returned from the initial strain to a minimum strain of 5% with a strain rate of 0.1 to 1500 mm/min and is held under this “holding strain” for a certain amount of time, typically from about a few seconds to about 60 seconds, during which the force being recovered is measured.
(iv) The percentage of the force recovered at any given time under the holding strain is then calculated with respect to the recorded maximum force from step (ii) and is reported as the force recovery of the composition at that time under the holding strain.

In one embodiment, the force recovery is evaluated by stretching the sample at a strain rate of 50 mm/min until it reaches a strain of 20%. Once this strain is achieved, the grips retract at a rate of 500 mm/min until a strain of 6% is attained. The sample's force recovery is then monitored for 12 seconds. The maximum percentage of force recovery reached within 12 seconds with respect to the maximum force reached during the initial stretch, is then calculated.

In one embodiment, the force recovery is evaluated by stretching the sample at a strain rate of 50 mm/min until it reaches a strain of 30%. Once this strain is achieved, the grips retract at a rate of 500 mm/min until a strain of 9% is attained. The sample's force recovery is then monitored for 12 seconds. The maximum percentage of force recovery reached within 12 seconds, with respect to the maximum force reached during the initial stretch, is then calculated.

In one embodiment, the force recovery is evaluated by stretching the sample at a strain rate of 500 mm/min until it reaches a strain of 40%. Once this strain is achieved, the grips retract at a rate of 500 mm/min until a strain of 12% is attained. The sample's force recovery is then monitored for 12 seconds. The maximum percentage of force recovery reached within 12 seconds, with respect to the maximum force reached during the initial stretch, is then calculated.

In one embodiment, the force recovery is evaluated by stretching the sample at a strain rate of 500 mm/min until it reaches a strain of 50%. Once this strain is achieved, the grips retract at a rate of 500 mm/min until a strain of 15% is attained. The sample's force recovery is then monitored for 12 seconds. The maximum percentage of force recovery reached within 12 seconds, with respect to the maximum force reached during the initial stretch, is then calculated.

In one embodiment, the force recovery is evaluated by stretching the sample at a strain rate of 50 mm/min until it reaches a strain of 20%. Once this strain is achieved, the grips retract at a rate of 50 mm/min until a strain of 10% is attained. The sample's force recovery is then monitored for 60 seconds. The maximum percentage of force recovery reached within 60 seconds, with respect to the maximum force reached during the initial stretch, is then calculated.

In one embodiment, the force recovery is evaluated by stretching the sample at a strain rate of 10 mm/min until it reaches a strain of 50%. Once this strain is achieved, the grips retract at a rate of 200 mm/min until a strain of 15% is attained. The sample's force recovery is then monitored for 60 seconds. The maximum percentage of force recovery reached within 60 seconds, with respect to the maximum force reached during the initial stretch, is then calculated.

The force recovery test is not limited to the aforementioned procedures and could include any other initial strains, holding times, holding strains, strain rates and sample size.

### General Embodiments of the Invention

The invention generally encompasses compositions and methods of manufacturing a biodegradable resin composition including, but not limited to, about 10 to about 99.99% (w/w) of one or more biodegradable thermoplastic polymers; about 0.01 to about 80% (w/w) of one or more biodegradable polyester elastomers; about 0 to about 40% (w/w) of one or more plasticizers; about 0 to about 80% (w/w) of one or more biodegradable modified starches; about 0 to about 20% (w/w) of one or more of inorganic fillers; about 0 to about 20% (w/w) of one or more of biomass or organic fillers; about 0 to about 10% (w/w) of one or more of additives such as coupling agents, compatibilizing agents, processing aids, chain extenders, pigments, initiators, peroxides, impact modifiers and pigments.

The methods of manufacturing of the aforementioned composition combinations may be achieved using mixing and melt-compounding equipment with adjustable and controllable temperatures and mixing speeds, such as a single or twin screw extruder or a batch kneader. In a batch kneader, the processing temperature profile may range from about 50 to about 250° C., and the processing time may be between about 1 to about 60 minutes. Alternatively, in scenarios where single or twin screw extrusion is employed, the temperature profile may range from about 50 to about 250° C., and the screw speed may range from about 50 to about 500 rpm. It should be noted that the processing conditions provided herein are not limiting and may vary based on other conditions such as ingredient ratios and processing equipment. The resulting product may be formed into films, sheets or more rigid parts using conventional cast extrusion, blown film extrusion, injection molding or compression molding techniques. Alternatively, the resulting product may be pelletized or crushed into powder and then injection molded or compression molded into plastic parts of higher thicknesses. The extrusion, injection or compression temperature is typically within the range used in the melt-processing and compounding of the resins and ingredients.

In certain embodiments, the compositions exhibit a bio-based carbon content of up to 100%.

In certain embodiments, the composition exhibits an MFI (melt flow index) of as low as 0.3 and as high as 55 g/10 min at 190° C. under a weight of 2.16 kg.

In certain embodiments, the composition exhibits a force recovery of more than 6% in machine direction, after an initial strain of 20% was applied at a rate of 500 mm/min and then reduced to a holding strain of 6% at a rate of 500 mm/min and held constant for 12 seconds.

In certain embodiments, the composition exhibits a force recovery of more than 6% in transverse direction, after an initial strain of 20% was applied at a rate of 500 mm/min and then reduced to a holding strain of 6% at a rate of 500 mm/min and held constant for 12 seconds.

In certain embodiments, the composition exhibits a force recovery of more than 9% in machine direction, after an initial strain of 30% was applied at a rate of 500 mm/min and then reduced to a holding strain of 9% at a rate of 500 mm/min and held constant for 12 seconds.

In certain embodiments, the composition exhibits a force recovery of more than 7% in transverse direction, after an initial strain of 30% was applied at a rate of 500 mm/min and then reduced to a holding strain of 9% at a rate of 500 mm/min and held constant for 12 seconds.

### EXAMPLES

Example 1: In synthesizing the biodegradable polyester elastomer, 907.3 grams of glycerol and 1292.7 grams of succinic acid, with a molar ratio of 0.9, were mixed in a 5.6-liter atmospheric pressure reactor at ambient temperature. The synthesis reaction was initiated by heating the reactor using a conventional heater equipped with a temperature controller, and the mixture was stirred vigorously with an overhead stirrer. The reaction temperature was maintained at 180° C. The reaction was completed in approximately 7.5 hours and it was stopped when a gelatinized elastomer was formed. After the reaction, the elastomer was allowed to cool to room temperature.

For further processing, a kneader was pre-heated to 230° C., and then 25.9 wt. % PLA and 33 wt. % PBAT were added. The temperature of the kneader was reduced to 190° C., and the polymers were mixed for 5 minutes at this temperature at a speed of up to 35 rpm until a uniform melt formed. Then, 10 wt. % ATBC as a plasticizer was added, and the mixing continued for another 5 minutes under shear and heat. Ten minutes into the process, 31 wt. % of the biodegradable polyester elastomer was loaded into the kneader, and after 5 more minutes, 0.1 wt. % of a processing aid was added. The mixture was then stirred for another 5 minutes under the presence of heat and shear. The resulting material was extracted from the kneader, cooled to room temperature, and subjected to crushing in a mechanical crusher to produce small particles. These particles were then fed into a cast film extruder, operated at a temperature profile of 140 to 160° C. and a screw speed of 70 rpm, to form a film. The film, with an average thickness of 0.35 mm and a width of 10-12 inches, was then chilled, guided through a set of chiller rollers and winding rollers, and collected on a spool. The mechanical properties and MFI of the produced resin and the extruded film were tested using a UTM and a melt flow indexer according to ASTM methods, as well as the force recovery test method defined previously. The results are detailed in Table 1.

Example 2: In synthesizing the biodegradable polyester elastomer, 432.8 grams of glycerol and 867.2 grams of succinic acid, with a molar ratio of 0.64, were mixed in a 3-liter atmospheric pressure reactor at ambient temperature. The synthesis reaction was initiated by heating the reactor using a conventional heater equipped with a temperature controller, and the mixture was stirred vigorously with an overhead stirrer. The reaction temperature was maintained at 180° C. for approximately 3 hours until a gelatinized elastomer was formed. After the reaction, the elastomer was allowed to cool to room temperature.

For further processing, a kneader was pre-heated to 180° C., and then 49.95 wt. % PBAT and 49.95 wt. % biodegradable polyester elastomer were added. The temperature of the kneader was reduced to 160° C., and the polymers were mixed for ten minutes before the addition of 0.1 wt. % processing aid and another 10 minutes of mixing under the presence of heat and shear at a speed of up to 35 rpm. The resulting material was extracted from the kneader, cooled to room temperature, and subjected to crushing in a mechanical crusher to produce small particles. These particles were then fed into a cast film extruder, operated at a temperature profile of 135 to 145° C. and a screw speed of 100 rpm, to form a film. The film, with an average thickness of 0.4 mm and a width of 10-12 inches, was then chilled, guided through a set of chiller rollers and winding rollers, and collected on a spool. The mechanical properties and MFI of the produced resin and the extruded film were tested using a UTM and a melt flow indexer according to ASTM methods, as well as the force recovery test method defined previously. The results are detailed in Table 1.

Example 3: In synthesizing the biodegradable polyester elastomer, 192 grams of glycerol and 308 grams of succinic acid, with a molar ratio of 0.8, were mixed in a 3-liter atmospheric pressure reactor at ambient temperature. The synthesis reaction was initiated by heating the reactor using a conventional heater equipped with a temperature controller, and the mixture was stirred vigorously with an overhead stirrer. The reaction temperature was maintained at 180° C. for approximately 1.5 hours until a gelatinized elastomer was formed. After the reaction, the elastomer was allowed to cool to room temperature.

For further processing, 45 wt. % PBSA, 26 wt. % PLA, 14 wt. % biodegradable polyester elastomers and 15 wt % ATBC were pre-mixed in a high-speed mixer until the pre-mixed was uniform.

The pre-mixed then was fed into a twin screw extruder with a screw speed of 100 rpm and a temperature profile between 140 to 175° C. to make pellets of this composition. These pellets were then fed into a cast film extruder, operated at a temperature profile of 160 to 170° C. and a screw speed of 50 rpm, to form a film. The film, with an average thickness of 0.37 mm and a width of 10-12 inches, was then chilled, guided through a set of chiller rollers and winding rollers, and collected on a spool. The mechanical properties and MFI of the produced resin and the extruded film were tested using a UTM and a melt flow indexer according to ASTM methods, as well as the force recovery test method defined previously. The results are detailed in Table 1.

TABLE 1
Mechanical properties of polymer blends
with polyester elastomer(s) and additives

| Properties | Example 1 | Example 2 | Example 3 |
|---|---|---|---|
| Thickness - mm | 0.35 | 0.4 | 0.37 |
| Stress at Yield | 2 | 2 | 4 |
| (MD) - MPa | | | |
| Stress at Yield | 2 | 1.8 | 3.2 |
| (TD) - MPa | | | |
| Stress at Break | 6.2 | 5.3 | 7.8 |
| (MD) - MPa | | | |
| Stress at Break | 4.7 | 4.5 | 4.5 |
| (TD) - MPa | | | |
| Young's Modulus | 44 | 26.3 | 61.9 |
| (MD) - MPa | | | |
| Young's Modulus | 41.4 | 24.7 | 66.6 |
| (TD) - MPa | | | |
| Strain at Yield | 11.6 | 12.5 | 16.2 |
| (MD) - % | | | |
| Strain at Yield | 11 | 12.2 | 13.7 |
| (TD) - % | | | |
| Strain at Break | 277.4 | 348.6 | 261.7 |
| (MD) - % | | | |
| Strain at Break | 273.6 | 315.8 | 129.2 |
| (TD) - % | | | |
| Force recovery | 6.2* | 9.9** | 3.7* |
| (MD) - % | | | |
| Force recovery | 6.3* | 7.4** | 2.5* |
| (TD) - % | | | |
| MFI @ 190° C., 2.16 | 15.8 | 0.3 | 28.8 |
| kg - gr/10 min | | | |

*Force recovery after 20% initial strain and at 6% holding strain,
**Force recovery after 30% initial strain and at 9% holding strain, (The strain rate for the force recovery test was 500 mm/min and the holding time was 12 seconds for all the examples.)

In certain embodiments, the compositions include one or more biodegradable thermoplastic polyesters. In these embodiments, one or more of these polymers are biodegradable polyesters including, but not limited to, polylactic acid, polycaprolactone, poly butylene succinate, polybutylene succinate adipate, poly butylene succinate terephthalate, polybutylene adipate terephthalate, or polyhydroxyalkanoates.

In certain embodiments, the compositions include one or more biodegradable polyester elastomer that is inclusive of but not limited to polyglycerol azelate (PGAz), polyglycerol sebacate (PGS), polyglycerol adipate (PGAd), polyglycerol succinate (PGSu), polyglycerol malonate (PGMa), poly(mannitol sebacate) (PMSe), poly(xylitol succinate) (PXSu), poly(erythritol-co-dicarboxylate) (PErD), poly(erythritol-co-adipate) (PErAd), poly(erythritol-co-pimelate) (PErPi), poly(erythritol-co-suberate) (PErSu), poly(erythritol-co-azelate) (PErAz) poly(erythritol-co-sebacate) (PErSe), poly(erythritol-co-dodecanedioate) (PErDo), poly(erythritol tetradecanedioate) (PErMyr), poly(xylitol-co-sebacate) (PXS), poly(sorbitol adipate) (PSA), poly(sorbitol-co-sebacate) (PSS), poly(sorbitol-co-citrate-co-sebacate) (PSCS), poly(sorbitol-co-tartaric-co-sebacate) (PSTS), poly(sorbitol-co-azelate) (PSAz), poly(maltitol-co-adipate) (PMaAd) and poly(maltitol-co-suberate) (PMaS).

In certain embodiments, the compositions include one or more plasticizers. In these embodiments the plasticizers include, but are not limited to, plant-based oils obtained from sources such as vegetables, nuts, grains, seeds, etc. Examples of such oils include, but are not limited to, corn oil, soybean oil, and glycerol. These plant-based oils can be used either in their virgin form or modified form (e.g., through epoxidation, carboxylation, hydroxylation, and amidation). Modified plant-based oils such as epoxidized soybean oil, epoxidized linseed oil, and a range of citrate plasticizers (e.g., acetyl tributyl citrate (ATBC), triethyl citrate (TEC), acetyl triethyl citrate (ATEC), tributyl citrate (TBC)), as well as isosorbide-type plasticizers, natural waxes, glycol, sugar alcohols (e.g. xylitol, sorbitol, lactitol, mannitol, erythritol, maltitol), isosorbide diester, and fatty acid methyl esters (FAME), are also encompassed.

In certain embodiments, the compositions further include modified starch which is a product of at least one starch or its derivatives, including any known starch material. Preferred starches can include any starch or modified starch that is initially in a native state as a granular solid, and obtained from sources such as, but not limited to cereal grains (e.g, corn, waxy corn, wheat, sorghum, rice, and waxy rice, which can also be used in the flour and cracked state), tubers of all types and nature such as potato, roots (tapioca (i.e., cassava and manioc), sweet potato, and arrowroot, modified corn starch, and the pith of the sago palm. Other ingredients of the modified starch could contain at least one polyol including but not limited to sorbitol, mannitol, galactitol, xylitol, ribitol, arabitol, erythritol, glycerol, threitol and a derivative thereof, and at least one organic acid such as saturated or unsaturated dicarboxylic acid including but not limited to succinic acid, sebacic acid, glutaric acid, hexanedioic acid, heptanoic acid, octanedioic acid, nonanedioic acid, and decanoic acid or a derivative thereof, and additives such as but not limited to water, crosslinkers, initiators, alkalizers, acidifiers, peroxides, coupling agents, fillers, compatibilizing agents, pigments and combinations thereof.

In certain embodiments, the biomass includes, but is not limited to, distillers' grains, vinasse, vinegar residues, wood fiber, starch, grains, agricultural cellulosic matter from including but not limited to straw, stalk, shive, hurd, bast, leaf, seed, fruit, and perennial grass, all in a non-continuous non-woven form including chopped pieces, particulates, dust or flour.

In certain embodiments, the inorganic filler includes, but is not limited to, wollastonite, mica, clay, calcium carbonate, glass fiber, talc, aluminum silicate, zirconium oxide, and gypsum.

In certain embodiments, the coupling agent or compatibilizer includes, but is not limited to, titanate, aluminate, y-aminopropyltriethoxysilane, Y-(2,3)epoxy(propoxy) propyltrimethoxysilane, y-methacryloxypropyltrimethoxysilane, lactic acid, formic acid, stearic acid, tannic acid, malic acid, citric acid, aspartic acid, ascorbic acid, acetic acid, tartaric acid.

In certain embodiments, the compositions further include additives such as coupling agents, compatibilizing agents, processing aids, chain extenders, initiators, peroxides, impact modifiers and pigments.

In other embodiments, the invention includes methods for preparing the biodegradable composition comprising the following steps; mixing uniformly and thoroughly all raw materials of the biodegradable composition at higher than ambient temperatures to prepare the biodegradable composition.

In other embodiments, the invention includes methods for preparing the biodegradable composition comprising the following steps; mixing uniformly and thoroughly, polymers at higher than ambient temperatures and then mixing uniformly and thoroughly with other raw materials of the biodegradable composition at higher than ambient temperatures to prepare the biodegradable composition.

In other embodiments, the invention includes methods for preparing the biodegradable composition comprising the following steps; mixing uniformly and thoroughly, specific groups or singular raw materials in certain order at higher than ambient temperatures to prepare the biodegradable composition.

In certain embodiments, the method further comprises forming any articles in any shape and rigidity using conventional polymer processing techniques such as thermoforming, hot press, vacuum forming, cast extrusion, film blowing, injection molding or compression molding.

In certain embodiments, the invention encompasses compositions and methods of making a disposable product, comprising the biodegradable composition of the invention, wherein the disposable products are packaging materials or consumer products.

While the present invention has been described with reference to a number of preferred embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A biodegradable resin composition comprising:
i. about 10 to about 99.99% (w/w) of one or more biodegradable thermoplastic polymers;
ii. about 0.01 to about 80% (w/w) of one or more biodegradable polyester elastomers;
iii. about 0 to about 40% (w/w) of one or more plasticizers;
iv. about 0 to about 80% (w/w) of one or more biodegradable modified starches;
v. about 0 to about 20% (w/w) of one or more of inorganic fillers;
vi. about 0 to about 20% (w/w) of one or more of biomass fillers; and
vii. about 0 to about 10% (w/w) of one or more of additives such as coupling agents, processing aids, compatibilizing agents, chain extenders, initiators, peroxides, impact modifiers and pigments;
wherein, the composition exhibits force recovery property shortly after being stretched to a certain strain and then returned to a lower strain and held for a period of time.

2. The biodegradable resin composition of claim 1, wherein the composition exhibits a minimum of about 5% force recovery within about 60 seconds, while being held at a holding strain of at least about 5% after returning from an initial strain of at least about 10% that falls beyond the elastic region on the tensile stress-strain curve of the resin composition.

3. The biodegradable resin composition of claim 1, where the biodegradable thermoplastic polymer is selected from the group consisting of biodegradable thermoplastic polyesters comprising polylactic acid, polycaprolactone, polybutylene succinate, polybutylene succinate adipate, polybutylene succinate terephthalate, polybutylene adipate-co-terephthalate, polyhydroxyalkanoates, and combinations thereof.

4. The biodegradable resin composition of claim 1, wherein the biodegradable polyester elastomer is a synthesized product of at least one polyol selected from the group consisting of sorbitol, mannitol, galactitol, xylitol, ribitol, arabitol, erythritol, glycerol, threitol and combinations thereof, and at least one organic acid selected from saturated or unsaturated dicarboxylic acid comprising to succinic acid, sebacic acid, glutaric acid, hexanedioic acid, heptanoic acid, octanedioic acid, nonanedioic acid, and decanoic acid or combinations thereof.

5. The biodegradable resin composition of claim 1, wherein the molar ratio of the polyol to the organic acid is about 0.32 to about 1.28.

6. The biodegradable resin composition of claim 1, wherein the biodegradable modified starch is selected from the group consisting of oxidized starch, esterified starch, plasticized starch, thermoplastic c starch, hydrophilicized starch, hydrophobicized starch, and enzyme-treated starch.

7. The biodegradable resin composition of claim 1, wherein the plasticizers comprise one or more plant-based oils obtained from vegetables, nuts, grains, seeds, or a combination thereof, wherein the oil is selected from the group consisting of corn oil, soybean oil, glycerol, epoxidized soybean oil, epoxidized linseed oil, fatty acid methyl esters, citrate plasticizers, acetyl tributyl citrate (ATBC), triethyl citrate (TEC), acetyl triethyl citrate (ATEC), tributyl citrate (TBC), isosorbide-type plasticizers, natural waxes, glycol, sugar alcohols, xylitol, sorbitol, lactitol, mannitol, erythritol, maltitol, isosorbide diester, fatty acid methyl esters (FAME), and combinations thereof.

8. The biodegradable resin composition of claim 1, where the inorganic fillers is selected from the group consisting of wollastonite, mica, clay, calcium carbonate, glass fiber, talc, aluminum silicate, zirconium oxide, sepiolite, gypsum and a combination thereof.

9. The biodegradable resin composition of claim 1, where the biomass comprises distillers' grains, vinasse, vinegar residues, wood fiber, virgin starch, grains, agricultural cellulosic matter, straw, stalk, shive, hurd, bast, leaf, seed, fruit, and perennial grass, which may consist of chopped pieces, particulates, dust, or flour or combinations thereof.

10. The biodegradable resin composition of claim 1, wherein the composition exhibits a 90% disintegration completion within about 180 to about 365 days at ambient temperature.

11. The biodegradable resin composition of claim 1, wherein the composition exhibits a 90% disintegration completion within about 180 to about 365 days in soil at ambient temperature.

12. The biodegradable resin composition of claim 1, wherein the composition exhibits more than 90% disintegration in less than about 12 weeks, and wherein the composition exhibits more than 90% biodegradation in less than 180 days under thermophilic temperature conditions.

13. The biodegradable resin composition of claim 1 wherein the biodegradable polyester elastomer is produced by reacting the ingredients at a temperature ranging from about 100 to about 250° C., continuing the reaction until the desired texture of the elastomer is achieved.

14. The method of producing the biodegradable resin composition of claim 1, in which ingredients are mixed and melt-compounded together in a polymer processing equipment or apparatus selected from a batch mixer, a twin screw extruder or a single screw extruder, at elevated temperatures for a time period of several seconds to several minutes.

15. The biodegradable resin composition of claim 1, where the bio-based carbon content of the composition is up to 100%.

16. The biodegradable resin composition of claim 1, where the bio-based carbon content of the biodegradable polyester elastomer is up to 100%.

17. The biodegradable resin composition of claim 1, for use in articles of any thickness and rigidity made by conventional polymer processing techniques comprising blown and cast film extrusion, compression molding and injection molding techniques.
